(19) United States
(12) Patent Application Publication
(10) Pub. No.: US 2021/0309382 A1
(43) Pub. Date: Oct. 7, 2021

(54) SMART COMBUSTION ENGINE

(71) Applicant: Volansi, Inc., San Francisco, CA (US)

(72) Inventor: Hoang Minh Chung, Jurong (SG)

(21) Appl. No.: 17/219,725

(22) Filed: Mar. 31, 2021

Related U.S. Application Data
(60) Provisional application No. 63/004,628, filed on Apr. 3, 2020.

(51) Int. Cl. B64D 31/06; B64C 39/02; B64D 27/04; B64D 37/32; B64D 27/24

(52) U.S. Cl. CPC B64D 31/06; B64C 39/024; B64D 27/04; B64C 29/0025; B64D 27/24; B64C 2201/044; B64C 2201/042; B64D 37/32

(57) ABSTRACT

Systems, devices, and methods are provided for a power delivery and drive system. A power delivery system can include an engine governing unit configured to deliver electrical power to a first electrical component. The power delivery system can include a smart engine electrically connected to the engine governing unit, the smart engine configured to deliver electrical power to the engine governing unit. The system can include a smart fuel tank operably connected to the smart engine and engine governing unit. And the system can include a battery operably connected to the engine governing unit, the smart battery configured to deliver electrical power to the engine governing unit.

### CROSS-REFERENCE TO RELATED APPLICATIONS

This application claims the benefit of U.S. Provisional Application No. 63/004,628, filed Apr. 3, 2020, which is hereby incorporated by reference in its entirety.

### BACKGROUND

An unmanned vehicle is a vehicle capable of travel without a physically-present human operator. An unmanned vehicle may operate in a remote-control mode, in an autonomous mode, or in a partially autonomous mode. Unmanned aerial vehicles (“UAVs”), such as drones, are used in a wide variety of applications. For example, drones may be used to transport material or goods from one location to another.

Drone aircraft are typically one of two types. A first type is a fixed-wing design, where lift is provided by one or more fixed wings and forward thrust is provided by a spinning propeller, ducted fan, or jet engine. A second type is a helicopter-type design where lift and forward thrust are provided by one or more vertically oriented rotors or rotary wings. Included in this second type is the so-called ‘quad-copter’ design which incorporates four vertical rotors. Manipulation of the relative thrust provided by each of the four rotors provides for variable vertical thrust and forward and lateral movement. Fixed-wing aircraft of the first type are generally efficient in long distance transportation. The various multicopter designs of the second type are generally less efficient but have the unique ability to take off vertically. These aircraft designs are said to be capable of vertical take-off and landing, or VTOL.

Additionally, aircraft may use various types of power for thrust and propulsion as well. One type of thrust or propulsion is electric thrust powered by battery power. Electric power may be easy to control by solid state electronics, but battery power storage density is relatively low, such that battery weight is often a significant concern in designing an aircraft. Furthermore, a fully-charged battery weighs approximately the same as a depleted battery. Another type of propulsion system for a drone aircraft is gasoline combustion system for gasoline powered propulsion. Under this type, fossil fuel burning may also be used in drone aircraft. Liquid fuel provides several advantages. First, it is very energy dense, so an internal combustion engine may produce significant lift or thrust from a given amount of fuel. Second, is that the weight of fuel decreases as it is consumed, such that a plane becomes lighter as it flies. However, gasoline engines can be complicated, require significantly more training for operators to understand how to operate and assemble gasoline engines.

Drone aircrafts that are capable of both long distance travel and can be operated at scale with minimum expertise for operators can greatly benefit modern drone capabilities. Improvements in designing, assembling, and operating such drones can also benefit the effectiveness and efficiency of modern drone systems.

### BRIEF SUMMARY

The present disclosure relates generally to an apparatus, systems, and methods of a smart power delivery and smart drive system for an aircraft. In one aspect, a power delivery system can include an engine governing unit configured to deliver electrical power to a first electrical component. In one aspect, the power delivery system can include a smart engine electrically connected to the engine governing unit, the smart engine configured to deliver electrical power to the engine governing unit. In one aspect, the system can include a smart fuel tank operably connected to the smart engine and engine governing unit. And in one aspect, the system can include a battery operably connected to the engine governing unit, the smart battery configured to deliver electrical power to the engine governing unit.

In one aspect, the battery can be configured to receive and store electric power from the engine governing unit. In one aspect, the first electrical component can be configured to draw direct current from the engine governing unit to power the first electrical component.

In one aspect, the smart fuel tank can be electrically connected to the engine governing unit, the smart fuel tank is configured to supply fuel to the smart engine. The smart fuel tank can include one or more sensors configured to measure fuel level of the smart fuel tank, measure fuel type inside the smart fuel tank, measure fuel temperature inside the smart fuel tank, or a combination thereof. In another aspect, the one or more sensors can be configured to detect a low level fuel, and signal a low fuel warning to the engine governing unit. And in another aspect, the system can include an electrically controlled fuel valve, the fuel valve can be controlled by the engine governing unit.

In one aspect, the engine governing unit can be configured to draw alternating current from the smart engine to power at least one of the engine governing unit or first electrical component, charge the smart battery, or a combination thereof. In one aspect, the engine governing unit can include a full wave rectifier configured to convert alternating current received from the smart engine into direct current. In another aspect, the engine governing unit can be configured to deliver electrical power to charge the battery when engine governing unit draws electrical power from the smart engine that is greater than the electrical power required deliver to the first electrical component.

In one aspect, the smart engine can further include a combustion engine, a throttle control servo configured to regulate the amount of fuel supplied to the combustion engine, one or more spark plugs, and an alternator configured to generate alternating current. In one aspect, the system can further include a full wave rectifier configured to convert alternating current supplied by the alternator into direct current. In one aspect, the system can further include one or more barometric sensors configured to monitor air pressure during flight. In another aspect, the one or more barometric sensors can be monitored by the engine governing unit. In one aspect, the system can further include one or more temperature sensors configured to monitor temperature during flight. In one aspect, the throttle control servo can be controlled and regulated by the engine governing unit, and determines the amount of electrical power supplied by the alternator.

In one aspect, the battery can be configured to cold start the engine governing unit, first electrical component, or a combination thereof, when the smart engine is inactive. In one aspect, each of the engine governing unit, smart engine, smart fuel tank, and battery can be part of a drone aircraft. In one aspect, the drone aircraft can include a fixed wing and one or more propellers electrically connected to the engine governing unit, the fixed wing configured to generate lift when the propellers are active. In one aspect, the first electrical component can be an electric configured to power and rotate one or more rotary wings configured to generate lift.

In one aspect, the first electrical component can include an electric motor configured to spin a propeller to generate lift, generate forward thrust, or a combination thereof.

And in one aspect, each of the engine governing unit, smart engine, smart fuel tank, and battery are modular components can be configured to be releasably attached to a drone aircraft.

Other examples are directed to systems and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 illustrates a system diagram of a smart engine system in accordance with various aspects of the subject technology.

FIG. 2 illustrates an example process for of operating a smart engine system in accordance with various aspects of the subject technology.

FIGS. 3A-3B illustrate a vehicle in accordance with various aspects of the subject technology.

### DETAILED DESCRIPTION

In this specification, reference is made in detail to specific examples of the disclosure. Some of the examples or their aspects are illustrated in the drawings.

For clarity in explanation, the disclosure has been described with reference to specific examples, however it should be understood that the disclosure is not limited to the described examples. On the contrary, the disclosure covers alternatives, modifications, and equivalents as may be included within its scope as defined by any patent claims. The following examples of the disclosure are set forth without any loss of generality to, and without imposing limitations on, the claimed disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially.

A power delivery and drive system for a drone aircraft is described below. Generally, a drone aircraft can be powered by a gasoline combustion engine for gasoline powered propulsion of the drone or an electric engine for electrically powered propulsion of the drone. Described below is a hybrid smart engine that is capable of electrically powered propulsion and can maintain the power output and flight time for long distance flights typically reserved for gasoline powered propulsion systems for a drone.

In one example, an aircraft, such as a drone or unmanned aerial vehicle (UAV) is described having a fuselage, one or more wings, one or more booms or boom assemblies. The one or more wings can span across a fuselage of the drone and a pair of booms can be attached to the each side of two sides of the one or more wings such that one boom is on one side of the fuselage and another boom is on another side of the fuselage, connected to the fuselage through the wing. In this example, the vertical takeoff propellers can be mounted onto the pair of booms.

In one example application, the aircraft described above can be light weight and having modular components. For example, an assembled drone can include various modular components such as a fuselage or body, a wing including a main wing, one or more tail wings including a vertical tail wing, diagonal tail wing, horizontal tail wing, or a combination thereof, one or more booms, propellers, rotors, engines, battery, computer hardware, cables and wiring, sensors, etc. In one example, an assembled drone can receive multiple configurations of components that are all designed to fit the drone assembly. For example, an aircraft manufacturing organization can manufacture different designs of a wing or mass manufacture the same design wing, or both, and each wing manufacture can be fitted onto the aircraft. The ability for modular components used for assembling a drone and the ability to swap out one component, with another can greatly increase the productivity, quality, efficiency, time, labor, of operating and storing an aircraft or fleet of aircraft for commercial purposes.

In this example, a power delivery system can also be modular such that the system configured to power operation, avionics, and propulsion, lift, and thrust, of a drone aircraft are also modular components that can be quickly assembled together, disassembled for diagnostics and easy storage, and for quick and cheap replacement parts in case any modular component, whether it is a wing, boom, fuselage making up the foundation of a drone aircraft, or the engine.

In such a case, the difference between being able to assemble a modular drone from hours to minutes or from multiple human operators to a single human operator for the whole assembly or portions of the assembly can drastically affect the effectiveness of aircraft fleet operation.

Additionally, the difference between a training a flight operator to understand each component of a gasoline engine, including throttle, ignition, power output, fuel and air intake, temperature and atmospheric air pressure affecting ignition of fuel, and so forth, and allowing an operator to simple request an outcome or desired effect of an power delivery system's performance in a drone can also drastically improve efficiency and effectiveness of aircraft fleet operation.

Below is an overview of a power delivery system that is configured with minimal components, minimum assembly requirements, and minimum training to understand how to use the power delivery system as an aircraft operator. In one example, a power delivery system includes an engine governing unit configured to manage and regulate portions of the power delivery system, regulate, monitor, and interface with other electrical components of the drone aircraft such as propulsion components or autopilot and avionics components, as well as power those components, a smart fuel tank, a smart engine configured to use liquid fuel to generate mechanical power and convert the mechanical power to electrical power, and a battery to initiate the ignition of the smart engine, store excess power from the smart engine during operation of the aircraft, and supply electrical power to other components of the aircraft.

The engine governing unit can be a single signal controller which can automatically start the engine and power and communicate with various components of the aircraft such as propulsion components or autopilot and avionics components. For example, the engine governing unit can automatically start the smart engine upon detecting a low rotations per minute (rpm) of the combustion engine inside the smart engine, or rotation of one or more propellers for generating thrust, or lift, or both. The engine governing unit can then automatically adjust throttle of the smart engine to effectively, through the engine air and fuel intake rate, power output, and ultimately power output from the engine governing unit to the electric motor of the drone aircraft, the desired force required to maintain or produce more lift and compensate for atmospheric condition differences during flight.

For example, under operation of the drone aircraft with the described electric motors to maintain a desired speed, or revolutions per minute, the engine governing unit can automatically determine the power adjustment required to accommodate for the changed environmental conditions, without the requiring the autopilot to make adjustments and continuously requesting different power input and output requests to the power delivery system. For example, if the autopilot, or human pilot remotely controlling the drone aircraft, requests a desired flight time, a desired average flight speed, a desired average altitude, and desired average rpm of each of the aircrafts propellers, the power delivery system can take the desired request and self-regulate to maintain the one or more desired requests during operation. For example, when the drone aircraft, under flight operation, moves from a low altitude, therefore having higher atmospheric pressure and higher temperature, moves to a high altitude, having lower atmospheric pressure and higher temperature, the amount of air intake required into a combustion engine of the smart engine to produce the same amount of mechanical power, the amount of electrical power, and current, needed for each electric motor to maintain the same rpm, or higher rpm for the same amount of lift in the lower atmospheric pressure, or a combination thereof, will change when the drone aircraft operates from a lower altitude to a higher altitude, and vice versa. In this example, each of the sensors, embedded in each of the power delivery system components will allow the engine governing unit to change the power output delivery, change the power draw from the smart engine, or a combination thereof. In one example, the changes in power output, power draw, required to maintain or reach a desired condition of the drone aircraft is performed within the power delivery system, and does not require a human operator, or autopilot system to constantly monitor changed conditions and constantly request new power output or power delivery from the engine governing unit.

In one example, the smart fuel tank can include built-in sensors to monitor liquid level, pressure, and temperature, and can be monitored by the engine governing unit. The liquid density, amount, and type can be automatically determined by the power delivery system, so an external autopilot, or human operator, does not need to monitor it constantly. In this example, the engine governing unit can then determine if the right type of fuel was used and issue a warning of wrong fuel, or low level fuel when necessary.

The smart engine can include a built-in starter, which can start the initial stage of operating the engine, the starter can be powered by the battery to cold start the engine. The smart engine can also include various sensors to monitor the operating condition of the engine itself such as pressure monitor of the fuel and air mixture, temperature sensor, accelerometer, gyroscopes, and inertial measurement units.

And the battery, or smart battery, can ensure that the smart engine can always perform a cold start through the engine governing unit, supply sufficient electrical power to the various external electrical components of the drone aircraft when the smart engine is not in use. The battery can also be charged through the engine governing unit under flight upon generating any excess electrical power from the smart engine above a desired amount requested or required from the external electrical components.

Thus, the power delivery system described above, and in detail below, allows a drone aircraft to receive the benefits of both having a gasoline engine and an electric propulsion system without the disadvantages produced from having only one of each in the drone aircraft.

### A. Smart Power and Drive System

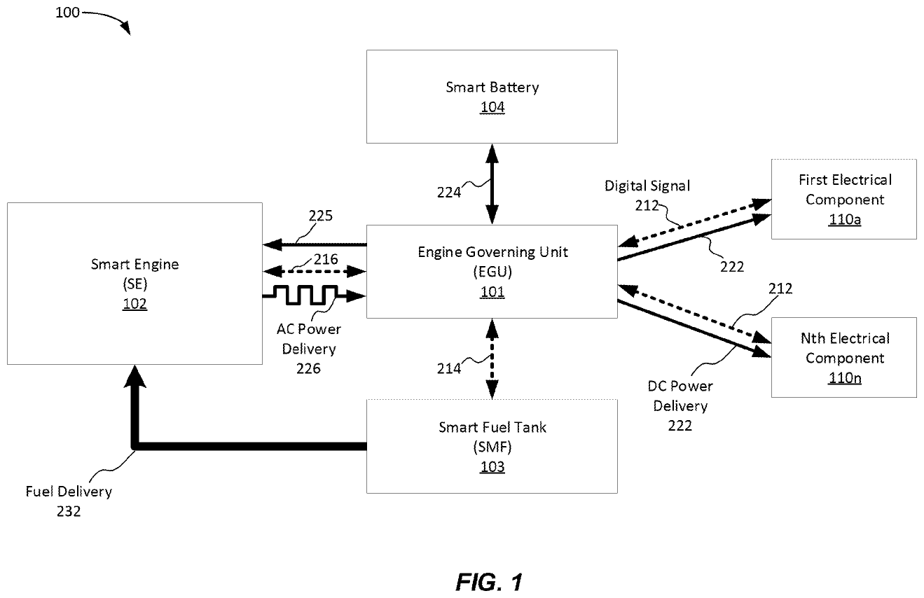

FIG. 1 illustrates a power delivery and drive system for an aircraft, such as a drone aircraft or unmanned aerial vehicle (UAV). FIG. 1 illustrates a system diagram of one or more modular components of a power delivery system electrically, and physically connected to each other to power portions of the drone aircraft. The modular components, or modular engine components, are configured to power and operate the drone aircraft including flight controls and operably generating lift and thrust to initiate and maintain flight. In one example, a power delivery system 100 includes an engine governing unit 101, a smart engine 102, a smart fuel tank 103, and a battery, or smart battery 104. The power delivery system 100 can be configured to power multiple electrically powered and operated components, such as first electrical component 110a, up to an nth electrical component 110n. In one example, the electrical components, such as first electrical component 110a, can be a computer, such as an autopilot system, the autopilot system including or electrically connected to a global positioning systems (GPS), one or more radios, sensors, lights, payload release and attach mechanisms, avionics, cameras, lidar, radar, electro optical sensors, gyroscope, accelerometers, inertial measurement units (IMU's), speakers, microphones, electric motors, propellers, motors configured to change the shape and size of an aircraft wing, and other various electrical components configured to operate an unmanned autonomous drone or aircraft. In another example, the global positioning systems (GPS), one or more radios, sensors, lights, payload release and attach mechanisms, avionics, cameras, lidar, radar, electro optical sensors, gyroscope, accelerometers, inertial measurement units (IMU's), speakers, microphones, electric motors, propellers, motors configured to change the shape and size of an aircraft wing, and other various electrical components configured to operate an unmanned autonomous drone or aircraft, can each be a separate electrical component, such as first electrical component 110a to nth electrical component 110n, powered and communicated directly with the engine governing unit 101.

In one example, the engine governing unit 101 can communicate digitally with the smart engine 102, smart fuel tank 103, and each of the electrical components such as electrical component 110a and electrical component 110n. For example, the engine governing unit can communicate digitally with each of the first electrical component 110a and electrical component 110n through digital signal 212. The engine governing unit can be a central hub for the power delivery system 100 including electronics, wiring, cabling, one or more microprocessors, configured to receive digital signals and transmit digital signals to the engine components of the power delivery system 100 or other components of the drone aircraft, or both. The engine governing unit 101 is configured to deliver electrical power to the first electrical component. In this configuration, the engine governing unit 101 can deliver direct current, or DC power to each of electrical components 110a and electrical component 110n, for example through a, for example DC power delivery 222 connection. Each of the electrical components, such as component 110a can draw direct current from the engine governing unit to power the electrical component.

In one example, each of the engine governing unit 101, smart engine 102, smart fuel tank 103, and smart battery 104 are each modular engine components of a drone aircraft.

The drone aircraft can include a fixed wing and one or more propellers electrically connected to the engine governing unit, the fixed wing configured to generate lift when the propellers are active. In one example, the first electrical component 110a is an electric motor configured to power and rotate one or more rotary wings configured to generate lift. The engine governing unit can power a plurality of electric motors or propulsion components, configured to generate thrust, lift, or both of a drone aircraft, directly from the engine governing unit through a DC current. The engine governing unit 101 can regulate the voltage, current, and power delivered through the DC power delivery 222 connection to each of the electrical components 110a and 110n. For example, a digital signal from a human controller, or an autopilot system embedded in the drone aircraft can signal the engine governing unit to deliver a constant or desired amount of current to each of the electric motors, for example, for maintaining a desired cruising speed during flight. As weather or other environmental conditions change the amount of power required for the electric motors to maintain a desired speed, or revolutions per minute, the engine governing unit 101 can automatically determine the power adjustment required to accommodate for the changed environmental conditions. For example, one or more sensors, such as temperature sensors, barometric sensors for sensing atmospheric pressure, accelerometers, inertial measurement units (IMU's), gyroscopes, GPS, or a combination thereof, can be used to measure speed, location, pressure for air intake for the smart engine, pressure for the amount of lift needed to generate a desired amount of lift during flight, temperature, etc. The sensors can be embedded inside the engine governing unit 101, can each be its own electrical component 110 electrically coupled to the engine governing unit 101, located in various physical locations on, inside, or attached to the drone aircraft, embedded in the smart engine 102, smart fuel tank 103, or a combination thereof. For example, when the drone aircraft, under flight operation, moves from a low altitude, therefore having higher atmospheric pressure and higher temperature, moves to a high altitude, having lower atmospheric pressure and higher temperature, the amount of air intake required into a combustion engine of the smart engine 102 to produce the same amount of mechanical power, the amount of electrical power, and current, needed for each electric motor to maintain the same rpm, or higher rpm for the same amount of lift in the lower atmospheric pressure, or a combination thereof, will change when the drone aircraft operates from a lower altitude to a higher altitude, and vice versa. In this example, each of the sensors, embedded in each of the power delivery system 100 components, or scattered in the drone and electrically and digitally connected to the engine governing unit 101, will allow the engine governing unit to change the power output delivery, change the power draw from the smart engine 102, or a combination thereof. In one example, the changes in power output, power draw, required to maintain or reach a desired condition of the drone aircraft is performed within the power delivery system 100, and does not require a human operator, or autopilot system to constantly monitor changed conditions and constantly request new power output or power delivery from the engine governing unit 101.

In one example, the engine governing unit 101, smart engine 102, smart fuel tank 103, and battery 104 are modular components configured to be releasably attached to a drone aircraft. In this example, a drone aircraft having modular components can be assembled such that a plurality of components can be compatible with each other. For example, a modular drone having a fuselage, one or more booms, one or more wings can be easily assembled and disassembled by one or more human operators. The modular drone aircraft in this example can also receive the power delivery system 100, as illustrated in FIG. 1, such that the power delivery system 100 includes modular components. Each of the engine governing unit 101, smart engine 102, smart fuel tank 103, and battery 104 can be connected to each other through a single cable, or harness, with one or more wires inside the cable, or one or more cables with wires inside the harness, the wires configured for electrically coupling components for digital communication, electrically coupling components for power delivery, or a cable that is a fuel line for delivery fuel.

For example, in a fleet of operational drone aircrafts, with a plurality of drones, a drone includes an engine governing unit, smart engine, smart fuel tank, and smart battery operably attached to one drone aircraft. In the case that one of the engine components fail, or fails to work, has a faulty connection, or a related cause of failure, only that particular component needs to be replaced, and can be replaced with another component of the same function. In this example, only one particular component of the power delivery system 100 was swapped out and the drone aircraft having a power delivery system 100 with three of the four original components are still operational.

In one example, the engine governing unit 101 can be operably connected to the smart fuel tank 103 with a single cable. The single cable can include one or more wires to digitally connect the engine governing unit 101 to the smart fuel tank 103, for example sending digital signal 214 from the engine governing unit 101 to the smart fuel tank 103, and vice versa. In this example, an operator only needs to connect one cable from the smart fuel tank 103 to the engine governing unit. The smart fuel tank 103 can be operably connected to the smart engine 102 with a fuel line. In one example, the engine governing unit 101 and smart engine 102 can also be connected with a single cable. The cable can include one or more wires configured to digitally connect the engine governing unit 101 to the smart engine 102, for example sending digital signal 216 from the engine governing unit 101 to the smart engine 102, and vice versa. Another wire or plurality of wires can be configured to delivery power from the smart engine 102 to the engine governing unit 101, such as an AC power delivery 226. In this example, the alternating current generated by an alternator of the smart engine 102 can be delivered to the engine governing unit 101 through a wire. In one example, the smart engine 102 can be cold started by the battery 104. In this example, the battery 104 can delivery DC power, for example through a DC power delivery 222 connection, to the engine governing unit 101 and then relayed to the smart engine 102 to cold start the engine for the internal combustion to initiate. For example, the DC power delivery can be a DC power delivery connection 225 through one or more wires from the engine governing unit 101 to the smart engine 102. In one example, the one or more wires used to deliver DC power from the engine governing unit 101 to the smart engine 102 and the one or more wires used to delivery AC power from the smart engine 102 to the engine governing unit 101 can be the same one or more wires. In one example, multiple cables can be used to connect the engine governing unit 101 with smart engine 102. In one example, the battery 104 can be connected to the engine governing unit 101 through a single cable having one or more wires configured to deliver DC power, for example a DC power connection 224, from the engine governing unit 101 to the battery 104 for charging the battery, or from the battery 101 to the engine governing unit 101, to effectively cold start the smart engine 102, or for powering electrical components, external to the power delivery system 100, such as first electrical component 110a and nth electrical component 110n, for example one or more electric motors, lights, sensors, computers, processors, cameras, communications systems and components, or a combination thereof.

In one example, cold starting the engine does not only refer to starting the engine when the drone aircraft is on the ground and is beginning to take off. In one example, cold starting the smart engine 102 from the battery 104 through the engine governing unit 101 can include initiating ignition of the smart engine 102 during flight while the smart engine has either been shut off, or has not started, or has a an ignition level too low to bring up by only bringing in more fuel and air mixture.

In one example, to preserver operational safety and reliability, system redundancy can be configured to the power delivery system 100. Each of the engine governing unit 101, smart engine 102, smart fuel tank 103, and smart battery 104, and its harness that connect to each other can have multiple parts with redundant purposes to ensure operations and safety if any one harness connection, or component fails or wears during operation. For example, two fuel lines can be connected from the smart fuel tank 103 to the smart engine 102 such that if one fuel line is broken, or somehow cannot supply fuel, the other redundant fuel line can serve as a backup to supply fuel to the smart engine 102.

In one example, the engine governing unit 101 can receive one or more signals from an electrical component such as first electrical component 110a. In this example, the electrical component can be an autopilot system. The autopilot system can include an avionics system and an autonomous or semi-autonomous computing platform for operating a drone aircraft. In one example, the autopilot system may interface with a number of components, including, for example, CPUs, autopilot modules, GPS sensors, inertial sensors, LIDAR systems, air speed sensors, magnetometers, barometers, gyroscopes, radio interfaces, lights, payloads, or other such sensors or systems, or peripheral devices. In one example, the peripheral devices can include one or more radio systems such as a 900 MHz radio, cellular LTE or Wi-Fi radio, or a satellite radio system such as an IRIDIUM satellite communications system. The components may assist the autopilot system in maintaining a desired course during operation of a drone, initiate take off, landing, releasing a payload, docking the aircraft, or avoiding weather or other physical conditions encountered upon flight. In this example, the autopilot system can send a single signal to the engine governing unit 101 with digital signal 212. The signal can be related to a request for a desired power output from the smart engine 102 or total electrical output from the engine governing unit 101 or power output from the power delivery system 100.

In one example, the signal can be related to a request for a desired flight speed, operating altitude, desired revolutions per minute of one or more propellers generating lift and thrust of the aircraft, rpm of the combustion engine, other desired outcomes related to operation of the aircraft during flight other than power output of the engine. In this example, the autopilot can request for the desired output by the smart engine 102 and engine governing unit 101 by requesting the outcome, and does not need to constantly monitor sensors and conditions inside each of the components of the power delivery system to request the components of the engine governing unit 101, smart engine 102, smart fuel tank 103, and smart battery 104, or a combination thereof. For example, as weather or other environmental conditions change the amount of power required for the electric motors to maintain a desired speed, or revolutions per minute, the engine governing unit 101 can automatically determine the power adjustment required to accommodate for the changed environmental conditions, without the requiring the autopilot to make adjustments and continuously requesting different power input and output requests to the power delivery system 100. For example, if the autopilot, or human pilot remotely controlling the drone aircraft, requests a desired flight time, a desired average flight speed, a desired average altitude, and desired average rpm of each of the aircrafts propellers, the power delivery system 100 can take the desired request and self-regulate to maintain the one or more desired requests during operation. For example, when the drone aircraft, under flight operation, moves from a low altitude, therefore having higher atmospheric pressure and higher temperature, moves to a high altitude, having lower atmospheric pressure and higher temperature, the amount of air intake required into a combustion engine of the smart engine 102 to produce the same amount of mechanical power, the amount of electrical power, and current, needed for each electric motor to maintain the same rpm, or higher rpm for the same amount of lift in the lower atmospheric pressure, or a combination thereof, will change when the drone aircraft operates from a lower altitude to a higher altitude, and vice versa. In this example, each of the sensors, embedded in each of the power delivery system 100 components will allow the engine governing unit to change the power output delivery, change the power draw from the smart engine 102, or a combination thereof. In one example, the changes in power output, power draw, required to maintain or reach a desired condition of the drone aircraft is performed within the power delivery system 100, and does not require a human operator, or autopilot system to constantly monitor changed conditions and constantly request new power output or power delivery from the engine governing unit 101.

In one example, the engine governing unit 101 can send engine related data back to the autopilot or to a remote computing system or server. The engine governing unit 101 can itself be an embedded controller configured to detect sensing signals, requests from autopilot or remote controller operating the drone, requests and logs of drone aircraft components such as propeller rpm, as well as the sensors and functionalities of the other components of the power delivery system 100. The engine governing unit 101 can send data related to flight logs, flight time, sensing data from each of the engine components such as the engine governing unit 101, smart engine 102, smart fuel tank 103, and battery 104 so that the autopilot, or human operator, pilot, reviewer, can monitor the drone aircraft during flight in real time related to the health of its components, battery charge level, fuel level, flight conditions, etc. The signal from the engine governing unit 101 to the autopilot or remote server can be sent through digital signal 212. In one example, the engine governing unit 101 is configured to supply electrical power, through DC power, to other UAV components such as electrical component 110a and 110n.

In one example, the smart engine 102 includes a combustion engine, a throttle servo configured to regulate the amount of fuel or air supplied to the combustion engine, one or more spark plugs for igniting fuel, and an alternator configured to generate alternating current for the engine governing unit 101. In one example, the throttle control, ignition of fuel, and air intake can be controlled by the engine governing unit. The combustion engine of the smart engine 102 can include one or more crankshafts, crankcase, one or more pistons, piston rings, spark plugs, a cylinder block, bearings, gaskets, flywheel, dampers, oil pans and oil filters, connecting rods, one or more valves, cooling systems including water cooling and air cooling, manifolds, exhaust, inlets, camshafts, belts, and other components assembled together for making an internal combustion engine. The smart engine 102 can also include an electric starter configured to cold start the combustion engine to begin the first cycle of fuel and air intake to power the smart engine. The electric starter can be powered by a DC power delivery 225 connection from the engine governing unit 101. The electric power for the cold start can be powered by the smart battery 104 initiated by the autopilot embedded in the drone aircraft or a remote signal from a human pilot or autopilot. In one example, the smart engine 102 can include a full wave rectifier configured to convert alternating current supplied by the alternator into direct current. In one example, the full wave rectifier or other rectifier can be located in the engine governing unit 101 such that alternating current is supplied by the alternator of the smart engine to the engine 102 governing unit 101. In one example, the smart engine 102 can also include one or more barometric sensors configured to monitor air pressure during flight. As the one or more sensors senses a change in pressure, the engine governing unit 101, or at the smart engine 102, can automatically adjust the fuel intake, the throttle control servo, the air intake, or a combination thereof, to generate the same amount of mechanical power output with a change of density of the air intake due to the changing altitude and air pressure effectively detected by the barometric sensors. In one example, the barometric sensors are monitored by the engine governing unit 101. In one example, the smart engine 102 also includes one or more temperature sensors configured to monitor temperature during flight. And in one example, the smart engine 102 can also include one or more sensors such as inertial measurement units, gyroscopes, accelerometers, speedometer, to measure speed, orientation, altitude, etc. of the drone aircraft during flight. As the speed or altitude changes, the smart engine can automatically detect the change and adjust power output to adjust to the change in conditions leading to a decrease in speed or altitude. For example, if the smart engine 102 and engine governing unit 101 has been requested to power the drone aircraft to a certain altitude, but under the current power output to the electric motors, the drone loses altitude, the smart engine 102 can automatically detect the decrease in altitude, and increase power output to the engine governing unit, which can allow the engine governing unit to increase power output to other electric components such as electric propellers, and therefore increasing thrust and lift to gain more altitude. This detection and adjustment would be accomplished without a human operator, or autopilot system monitoring and manually request the adjustment from the power delivery system 100. In one example, the sensors can also be embedded in the engine governing unit 101 and monitored from the engine governing unit 101 and adjustments can be made, requested, and sent to the smart engine 102 from the engine governing unit 101. The smart engine 102, or engine governing unit 101, can monitor and change configurations of subcomponents of the smart engine, adjust fuel intake, air intake, or a combination thereof, automatically due to the sensing of a change in temperature by the temperature sensors. In one example, the throttle control servo can be controlled and regulated by the engine governing unit 101, which effectively determines the amount of electrical power delivered by the alternator. As the fuel intake or air intake increases, or the fuel density or air density increase, more mechanical power can be generated by the combustion engine, which can effectively allow the alternator to convert more mechanical power to higher alternating current.

In one example, the smart fuel tank 103 is operably connected to the smart engine 102 and engine governing unit 101. In this example, the smart fuel tank 103 is configured to supply fuel to the smart engine. The smart fuel tank 103 can detect a request for fuel delivery directly from the smart engine 102 by detecting that a bigger fuel intake from the smart fuel tank 103. The smart fuel tank 103 can also supply fuel to the smart engine 102 by detecting and receiving signals from the engine governing unit 101 to supply more or less, or stop supplying fuel to the smart engine 102. In one example, wherein the smart fuel tank includes one or more sensors configured to measure fuel level of the smart fuel tank, measure fuel type inside the smart fuel tank, measure fuel temperature inside the smart fuel tank, or a combination thereof. In this example, the smart fuel tank can include sensors that can detect the type of fuel that was pumped into the smart fuel tank 103 and detect whether the correct type of fuel, at least for the desired type of operation, was used. In one example, the sensor is a resistance fuel tank sensor which can determine the level of fuel based on the resistance experienced by the sensor. In one example, the smart fuel tank 103 is configured to detect a low level fuel and signal a low fuel warning to the engine governing unit 101, or other electrical components through the engine governing unit 101. In one example, the smart fuel tank 103 includes an electrically controlled fuel valve configured to control and delivery the amount, rate, of fuel to the smart engine 102. The fuel valve can be regulated and controlled by the smart engine 103, or by the engine governing unit 101. In one example, the engine governing unit 101 monitors and controls the sensors embedded or coupled to the smart fuel tank 103 including monitoring fuel tank temperature, fuel level, pressure, etc. In one example, the smart fuel tank 103 includes a liquid filter to filter clean fuel to the smart engine 102.

In one example, the engine governing unit 101 is configured to draw alternating current from the smart engine 102 to power and operate at least one of the engine governing unit 101 or first electrical component 110a, charge the smart battery 104, or a combination thereof. In one example, the engine governing unit 101 includes a full wave rectifier configured to convert alternating current received from the smart engine into direct current. In one example, the engine governing unit is configured to delivery electrical power to charge the battery when engine governing unit draws electrical power from the smart engine that is greater than the electrical power required deliver to the first electrical component.

In one example, during starting the power delivery system 100, starting the drone aircraft and conducting starting diagnostics, flight, takeoff, or landing, or other modes of operation, the electrical components, such as sensors, computers, aviation board, electric motors, or a combination thereof, can be powered solely by the smart battery 104. The smart battery 104 can supply DC power to the engine governing unit 101, and relayed to the individual components of the drone aircraft. The battery can be the sole source of DC power due to failure of the smart engine 102, low or depleted fuel supply in the smart fuel tank 103, overheating of the smart engine 102, or other factors such that allow the battery 104 to sufficiently power and operate the electrical components of the drone aircraft as the sole source of power.

Thus, the power delivery system described above, allows a drone aircraft to receive the benefits of both having a gasoline engine and an electric propulsion system without the disadvantages produced from having only one of each in the drone aircraft. Additionally, the power delivery system receives the benefit of long range flight capability controlled by a single pulse width modulation (PWM) interface with a controller area network signal from an autopilot. In this configuration, the autopilot can focus and allocate more processing power to regulate other parts of the UAV.

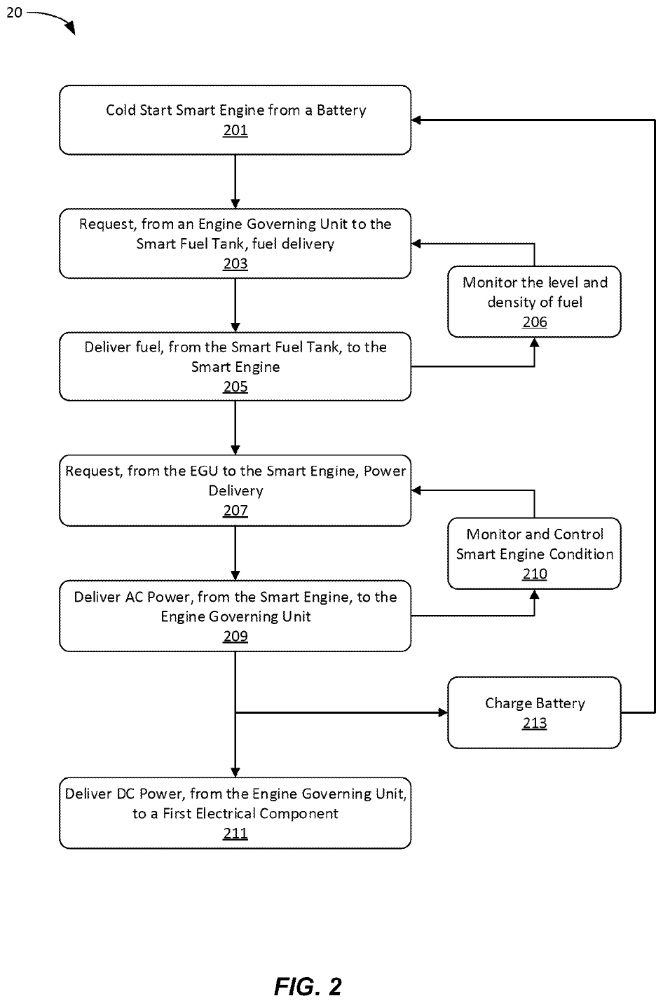

FIG. 2 illustrates a flow chart of an example processes for operating a power delivery system. In one example, the power delivery system can be configured for a drone aircraft.

In the example flow diagram 20 of FIG. 2, at block 201, a power delivery system can cold start a smart engine component from a battery.

At block 203, the system can request, from an engine governing unit to a smart fuel tank, fuel delivery. The engine governing unit can send an electrical signal to the smart fuel tank for delivery fuel to the smart engine.

At block 205, the system can deliver fuel, from the smart fuel tank, to the smart engine.

At block 206, the system can monitor the level and density of fuel. In this step, the system can monitor the level of fuel during operation of a drone aircraft while the smart fuel tank is continuously delivery fuel to the smart engine. Once a fuel level is below a certain threshold, or the drone aircraft is no longer in operation, or has landed and no longer needs to produce thrust, or the battery itself is sufficient to power electrical components of the drone aircraft.

At block 207, the system can request, from the engine governing unit to the smart engine, power delivery.

At block 209, the system can deliver AC power, from the smart engine, to the engine governing unit. In this example, the smart engine is configured with an alternator that can convert rotational power into alternating current to be delivered to the engine governing unit.

At block 210, the system can monitor and control conditions of the smart engine. For example, the smart engine can receive a signal from the engine governing unit to deliver a certain amount of power to the engine governing unit and will adjust fuel injection, throttle control, and other subcomponents of an internal combustion engine to deliver a desired amount of power through the alternator of the smart engine to the engine governing unit. In one example, the smart engine can also include gyroscope and accelerometers and other sensors such as barometric and temperature sensors to monitor motion, temperature, atmospheric pressure, and can adjust configurations of the subcomponents of the combustion engine based on the measurements of the sensors. For example, if the engine governing unit receives a signal from an autopilot control system to maintain a certain rpm level of one or more propellers of the drone aircraft, the engine governing unit can send a digital signal to the smart engine to adjust air intake, fuel intake, or both, to maintain the rpm level of the one or more propellers, even when conditions such as temperature, pressure, and speed of the drone aircraft changes in the physical environment during flight.

At block 211, the system can deliver DC power, from the engine governing unit, to a first electrical component. In this example, the engine governing unit can include a full wave rectifier or other rectifier which converts alternating current supplied by the smart engine, to direct current when delivered from the engine governing unit to another electrical component, such as a first electrical component.

And at block 213, the system can charge the battery from the engine governing unit. For example, the direct current delivered from the engine governing unit to another electrical component can also be delivered to the battery to charge the battery.

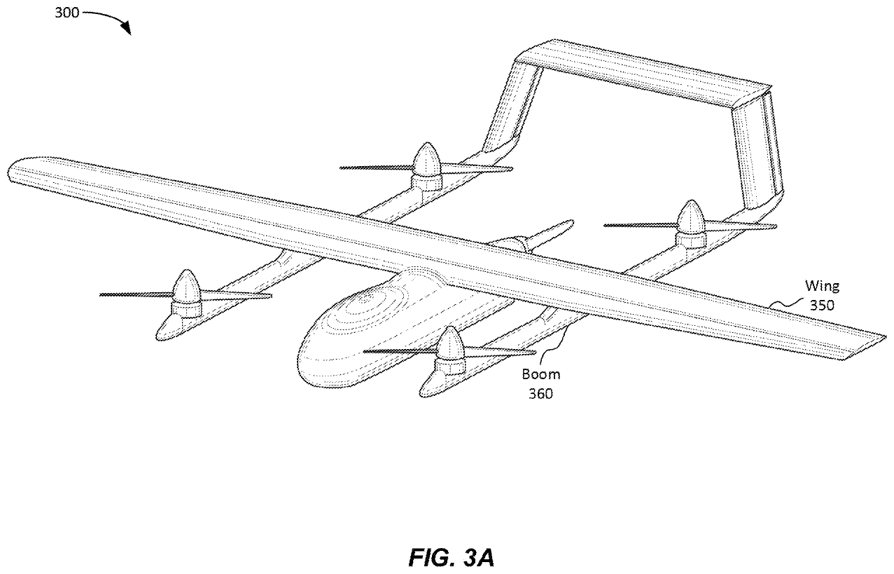

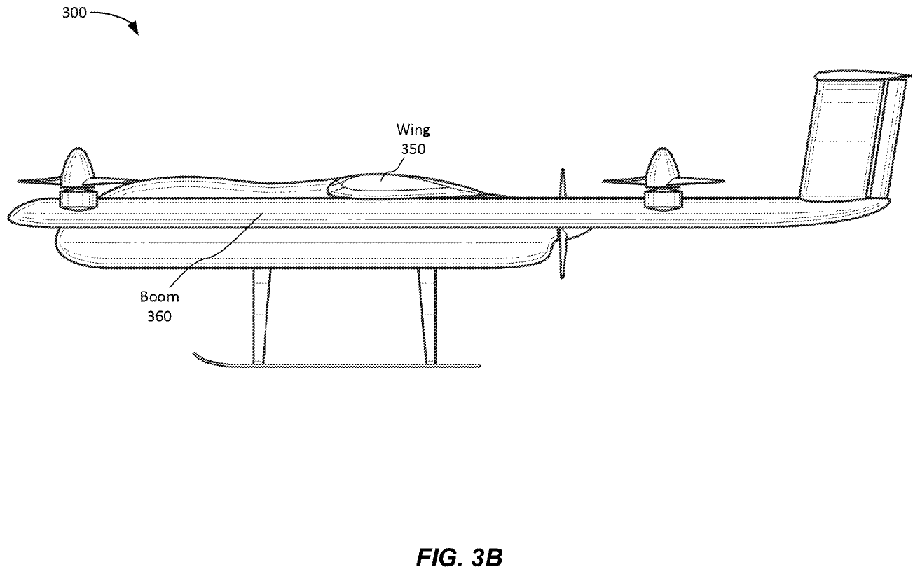

FIG. 3A-3B illustrates example embodiments of a drone. The drone depicted in FIGS. 3A-3B, such as drone 300, is configured with a pair of booms and a tail. In this example, the drone 300 can include a fuselage, a wing 350 that spans across the fuselage perpendicular to a length of the fuselage. Securely suspended beneath the wing 350 are a pair of booms 360. A tail, tail wing, or an additional rear wing of the drone is connected to each of the booms 360 of the drone. In this embodiment, each boom includes a pair of VTOL propellers. One boom 360 is configured to physically connect to a first side of the wing 350 and the second boom 360 is configured to physically connect to a second side of the wing 350. The booms 360 are also connected to each other through a tail wing at each of the rear portions of the booms 360. In this embodiment, the fuselage, wing 350, booms 360, and tail wing can be modular such that each component can be swapped out for a different unit of the same component. In one example, the tail wing can be attached to the drone at the booms of the drone with a locking apparatus. The locking apparatus can be configured to securely attach the tail wing to the boom and configured to be removed from the boom with a quick release mechanism. When fully assembled, as illustrated in FIGS. 3A-3B, the drone 300 can include five propellers, four vertically mounted propellers for VTOL and one horizontally mounted propeller for long range flight. In one example, the drone 300 can include 8 vertically mounted propellers for VTOL such that dual propellers are positioned on each end of the two booms 360.

The terminology used herein is for the purpose of describing particular aspects only and is not intended to be limiting of the disclosure. As used herein, the singular forms “a”, “an”, and “the” are intended to comprise the plural forms as well, unless the context clearly indicates otherwise. It will be further understood that the terms “comprises”, “comprising”, or a combination thereof, when used in this specification, specify the presence of stated features, integers, steps, operations, elements, and/or components, but do not preclude the presence or addition of one or more other features, integers, steps, operations, elements, components, and/or groups thereof.

While the disclosure has been particularly shown and described with reference to specific examples thereof, it should be understood that changes in the form and details of the disclosed examples may be made without departing from the scope of the invention. Although various advantages, aspects, and objects of the present disclosure have been discussed herein with reference to various examples, it will be understood that the scope of the disclosure should not be limited by reference to such advantages, aspects, and objects. Rather, the scope of the disclosure should be determined with reference to the claims.

What is claimed is:

1. A power delivery system, comprising:
an engine governing unit configured to deliver electrical power to a first electrical component;
a smart engine electrically connected to the engine governing unit, the smart engine configured to deliver electrical power to the engine governing unit;
a smart fuel tank operably connected to the smart engine and engine governing unit; and
a battery operably connected to the engine governing unit, the battery configured to deliver electrical power to the engine governing unit; and
wherein the engine governing unit is configured to draw alternating current from the smart engine to power at least one of the engine governing unit or first electrical component, charge the battery, or a combination thereof.
wherein the first electrical component is configured to draw direct current from the engine governing unit to power the first electrical component.

2. The power delivery system of claim 1, wherein the battery is configured to receive and store electric power from the engine governing unit.

3. The power delivery system of claim 1, wherein the smart fuel tank is electrically connected to the engine governing unit, the smart fuel tank is configured to supply fuel to the smart engine.

4. The power delivery system of claim 3, wherein the smart fuel tank includes one or more sensors configured to measure fuel level of the smart fuel tank, measure fuel type inside the smart fuel tank, measure fuel temperature inside the smart fuel tank, or a combination thereof.

5. The power delivery system of claim 4, wherein the one or more sensors is configured to detect a low level fuel and signal a low fuel warning to the engine governing unit.

6. The power delivery system of claim 3, further comprising an electrically controlled fuel valve, the fuel valve controlled by the engine governing unit.

7. The power delivery system of claim 6, wherein the engine governing unit includes a full wave rectifier configured to convert alternating current received from the smart engine into direct current.

8. The power delivery system of claim 6, wherein the engine governing unit is configured to delivery electrical power to charge the battery when engine governing unit draws electrical power from the smart engine that is greater than the electrical power required deliver to the first electrical component.

9. The power delivery system of claim 1, wherein the smart engine comprises:
a combustion engine;
a throttle control servo configured to regulate the amount of fuel supplied to the combustion engine;
one or more spark plugs; and
an alternator configured to generate alternating current.

10. The power delivery system of claim 9, further comprising a full wave rectifier configured to convert alternating current supplied by the alternator into direct current.

11. The power delivery system of claim 9, further comprising one or more barometric sensors configured to monitor air pressure during flight.

12. The power delivery system of claim 11, wherein the one or more barometric sensors is monitored by the engine governing unit.

13. The power delivery system of claim 9, further comprising one or more temperature sensors configured to monitor temperature during flight.

14. The power delivery system of claim 9, wherein the throttle control servo is controlled and regulated by the engine governing unit, and determines the amount of electrical power supplied by the alternator.

15. The power delivery system of claim 1, wherein the battery is configured to cold start the engine governing unit, first electrical component, or a combination thereof, when the smart engine is inactive.

16. The power delivery system of claim 1, wherein each of the engine governing unit, smart engine, smart fuel tank, and battery are part of a drone aircraft.

17. The power delivery system of claim 16, wherein the drone aircraft comprises a fixed wing and one or more propellers electrically connected to the engine governing unit, the fixed wing configured to generate lift when the propellers are active.

18. The power delivery system of claim 16, wherein the first electrical component is an electric motor configured to power and rotate one or more rotary wings configured to generate lift.

19. The power delivery system of claim 1, wherein the first electrical component includes an electric motor configured to spin a propeller to generate lift, generate forward thrust, or a combination thereof.

20. The power delivery system of claim 1, wherein each of the engine governing unit, smart engine, smart fuel tank, and battery are modular components configured to be releasably attached to a drone aircraft.

21. A method of distributing power to a drone aircraft, the method comprising:
cold starting a smart engine of a power delivery system, from a battery of the power delivery system;
requesting, from an engine governing unit to a smart fuel tank, fuel delivery to the smart engine;
delivering fuel, from the smart fuel tank, to the smart engine;
requesting, from the engine governing unit to the smart engine, power delivery;
delivering AC power, from the smart engine, to the engine governing unit; and
delivering DC power, from the engine governing unit, to a first electrical component.

22. The method of claim 21, further comprising monitoring a level and density of fuel of the drone aircraft under operation.

23. The method of claim 21, further comprising monitoring and controlling conditions of the smart engine including power output adjustment, throttle control adjustment, air intake rate, temperature of the smart engine, or a combination thereof.

24. The method of claim 21, further comprising charging the battery from the smart engine and through the engine governing unit.
